(19) United States
(12) Patent Application Publication
(10) Pub. No.: US 2019/0026658 A1
(43) Pub. Date: Jan. 24, 2019

(54) CONNECTED USER COMMUNICATION AND INTERFACE SYSTEM WITH TRAVEL INTERRUPTION SERVICE

(71) Applicant: AVIS BUDGET CAR RENTAL, LLC, Parisppany, NJ (US)

(72) Inventors: BERNARD ALTUS, PARSIPPANY, NJ (US); JOHN TURATO, PARSIPPANY, NJ (US)

(21) Appl. No.: 15/986,528

(22) Filed: May 22, 2018

Related U.S. Application Data
(60) Provisional application No. 62/538,543, filed on Jul. 28, 2017.
(60) Provisional application No. 62/509,599, filed on May 22, 2017.

(51) Int. Cl. G06Q 10/02; G06Q 50/30; G05D 1/02

(52) U.S. Cl. CPC G06Q 10/02; G05D 1/0297; G06Q 50/30

(57) ABSTRACT

A system and related methods for management of communications and interfacing between a user and a connected fleet of vehicles, including a system for proactively responding to travel disruption or interruption events, including providing an alternative solution for a connected user to get to their desired destination, or to easily modify, change or cancel existing reservation data. The system provides notifications to the user of travel disruption events (delays, diversions, cancellations) in their in their flight or rail travel information. Response options presented to the connected user with the message vary depending upon the circumstances of the disruption, and the distance between the origination location and the destination locations. In some circumstances, the user is provided the option of a one-way vehicle rental.

This application claims benefit of and priority to U.S. Provisional Application Nos. 62/509,599, filed May 22, 2017, and 62/538,543, filed Jul. 28, 2017, and is entitled to the benefit of those filing dates. The specifications, drawings, appendices and complete disclosures of U.S. Provisional Applications No. 62/509,617, filed May 22, 2018, No. 62/509,599, filed May 22, 2018, and No. 62/538,543, filed Jul. 28, 2017, are incorporated herein in their entireties by specific reference for all purposes.

### FIELD OF INVENTION

This invention relates to a system and related methods for management of communications and interfacing between a user and a connected fleet of vehicles. More particularly, this invention relates to a system and related methods for proactively responding to travel disruption or interruption events.

### SUMMARY OF INVENTION

In several embodiments the present invention comprises a unique, single integrated platform for communications between a connected user and a connected fleet management system. The connected fleet management system manages fleet planning, in-fleeting operations, vehicle acquisition and provisioning, vehicle assignment, vehicle transfers (i.e., to another fleet or another component fleet in the larger fleet), vehicle use operations (i.e., reservations, use and return by a customer, member, driver or user), vehicle servicing, vehicle maintenance and repairs, and de-fleeting operations (e.g., removal of the vehicle from the fleet, return to manufacturer, or sale to third parties).

Within this context, the system provides a variety of user-facing applications and interfaces, including applications which may be installed and run on a mobile computing device of the user for various functions. These functions include, but are not limited to, user registration or enrollment, user reservation management, user access to a fleet vehicle, communication between the user and the fleet management system during use (including, but not limited to, providing roadside or emergency assistance), and return of the fleet vehicle.

In several exemplary embodiments, the present invention comprises a travel disruption or interruption service that, depending on the situation, provides an alternative solution for a connected user to get to their desired destination, or to easily modify, change or cancel existing reservation data. For a connected user at a origination location with a reservation for a fleet vehicle at a destination location, the service provides the connected user an option to provide the airline name and flight number as part of the reservation. If the user has enabled push notifications through the system application on their mobile device, and/or has chosen to receive text messages (i.e., SMS text), the system can provide notifications to the user of changes in their flight information. Flight information can be obtained directly from the airline or airport, or travel services. For relatively minor flight delays, this allows the fleet system to adjust the “pick-up” time of the vehicle at the destination location. The system may also provide notifications to the user if the user's flight is delayed by a pre-established amount of time, diverted, or cancelled (individual flight cancelled, or origination and/or destination airports shut down) (collectively, these are referred to herein as flight disruption events). In several embodiments, the system first checks to ensure that no conflicting messages have been pushed or sent to the connected user.

In all three cases, the user may be provided the option to cancel or modify the reservation at the destination location (i.e., through the mobile device app in the case of a push notification, or through a telephone call to a number provided in the SMS message). If the distance between the flight origination location and the destination location is within a pre-established drivable distance, the user also may be provided the option to modify their reservation to a one-way vehicle rental from the origination location to the destination location. The vehicle reservation at the destination location is effectively canceled, and a substitute vehicle reservation at the origination location is made for one-way travel.

The pick-up vehicle location can default to the origination location airport, although in some cases the user may be provided other pick-up locations in the area from which to choose. The pick-up time may default to the original flight departure time, or a set time prior to the flight departure time (e.g., 1 to 2 hours prior), although the user may input another pick-up time. The vehicle may default to the same or similar vehicle type as made in the original vehicle reservation, although the user may select another available vehicle type. The default return time for the vehicle at the destination location may default to the return time for the original reservation, although the user may input another return time.

If the distance is not a drivable distance, or if the user decides not to accept the one-way booking option, the vehicle reservation at the destination location may be modified or canceled.

In one exemplary embodiment, the system maintains a “drivable distance” departure and destination locations (e.g., cities or airports) table. In other embodiments, the system may calculate dynamically the driving distance and time based on distance, weather conditions, road and traffic conditions, and the like. In some embodiments, the user may specify a maximum drivable distance in their application preferences, so that the option for a one-way booking may be presented for distances other than the “drivable distance” determined by the system.

The connected user then arrives at the origination location, drives the vehicle to the destination location, and uses the vehicle as planned. Assuming there are no problems with the departing return flight from the destination location, the user returns the vehicle at the destination location fleet vehicle facility and completes their travel. The user also may elect to drive the vehicle back to the origination location.

In some circumstances, the user may be in mid-travel and in possession of a rental vehicle when the flight event (delay, diversion, cancellation) arises. The system sends notifications of the event to the connected user (via push notification through the mobile application or via SMS text messaging, as described above), providing options depending upon the circumstances. In all three event cases, the user may be provided the option to modify the reservation at the destination location, typically by extending the rental and returning at a later time or date. In circumstances similar to those giving rise to the one-way option above, the user also may be provided the option to convert the vehicle rental to a one-way rental back to the connected user's origination location.

In several embodiments, the system may send notifications without a flight actually being formally delayed, diverted, or cancelled. For example, the system may detect a significant number of flight cancellations occurring at an airport, and send a notification to the user of the situation, providing them advance warning of a possible or probable flight event. Alternative travel options may then presented as described above.

### BRIEF DESCRIPTION OF THE DRAWINGS

FIG. 1 illustrates the system architecture of a mobile device used to communicate with a vehicle and reservation server of a connected fleet.

FIG. 2 illustrates a portion of a mobile device user interface displaying a map of vehicle locations

FIG. 3 illustrates a portion of a mobile device user interface displaying information regarding the vehicles available at a selected location.

FIG. 4 illustrates a portion of a mobile device user interface for selecting a “favorite” vehicle or vehicle type.

FIG. 5 illustrates a mobile device user interface for recording damage to a vehicle.

FIG. 6 illustrates a mobile device user interface for reviewing and electronically signing an invoice.

FIGS. 7A-C show examples of a mobile application notification of a flight disruption event (flight delay, diversion, cancellation) with suggested alternative travel option of a one-way vehicle rental.

FIGS. 8A-D show examples of a mobile application notification of a flight disruption event (flight delay, diversion, cancellation) with suggested alternative travel option of modification of an existing vehicle reservation or cancellation of an existing vehicle reservation.

FIG. 9 shows examples of a mobile device text message notification of a flight disruption event (flight cancellation, delay, diversion) with suggested alternative travel options of a one-way vehicle rental, modification of an existing vehicle reservation, or cancellation of an existing vehicle reservation.

FIG. 10 shows an example of mobile device text message notification of a significant number of flight cancellations at an airport, with suggested alternative travel options.

FIGS. 11A-C show examples of mobile device application user interface screens for modification of an existing vehicle rental.

FIG. 12 shows an example of a mobile application notification of a flight disruption event (flight delay, diversion, cancellation) with the option to cancel an existing vehicle reservation.

FIG. 13 shows an example of a mobile application notification of a flight cancellation with the option to cancel an existing vehicle reservation.

FIGS. 14 and 15 show examples of mobile device application user interface screens for cancellation of an existing vehicle rental.

### DETAILED DESCRIPTION OF EXEMPLARY EMBODIMENTS

In various exemplary embodiments, the present invention comprises a system and related methods for management of communications and interactions between a user and a connected fleet of vehicles. A “connected fleet” comprises a plurality of vehicles, some or all equipped with (i) on-board sensors and computer systems for monitoring and capturing the operational status and performance of vehicle systems and components, and (ii) one or more electronic control and/or communications units for two-way or multiple pathway communication with one or more fleet management servers or networks, outside data centers or sources, other vehicles, and individual user or driver computing devices. A “connected user” comprises a user with one or more computing devices, including, but not limited to, mobile computing devices such as smart phones, tablets, or wearable devices, that provide extended, continuous, uninterrupted electronic communications with various computer networks, devices, and systems, including, but not limited to, elements of the connected fleet computing system or network, regardless of where the user is and how they are connected. Connected users may include, but are not limited to, drivers, passengers, customers, renters, members of a vehicle sharing service, employees, owners, or operators.

Vehicles in a connected fleet may include, but are not limited to, automobiles, trucks, vans, buses, motorcycles, bicycles, mopeds, construction and utility vehicles, battery-powered carts, golf carts, airplanes, aircraft, boats, watercraft, and the like. Vehicles may be controlled by a driver or user, or autonomous or semi-autonomous. A fleet may include, but is not limited to, a rental vehicle fleet, shared vehicle fleet, peer-to-peer or business-to-business transportation fleet, taxi-cab fleet, corporate vehicle fleet, municipal or governmental agency vehicle fleet, bus fleet, utility or construction vehicle fleet, truck fleet, or combinations thereof. A fleet may be homogenous or heterogeneous (i.e., a mixed fleet). Fleets may be combined to make larger fleets, and fleets may also be sub-divided into component fleets by various parameters (e.g., type of use, type of customer or user, country, state, city, county, or other defined geographical area). The term “fleet” as used herein includes fleets of all types and various combinations, components or sub-divisions thereof.

As described in detail below, in several embodiments the present invention comprises a unique, single integrated platform for communications between a connected user and a connected fleet management system. The connected fleet management system manages fleet planning, in-fleeting operations, vehicle acquisition and provisioning, vehicle assignment, vehicle transfers (i.e., to another fleet or another component fleet in the larger fleet), vehicle use operations (i.e., reservations, use and return by a customer, member, driver or user), vehicle servicing, vehicle maintenance and repairs, and de-fleeting operations (e.g., removal of the vehicle from the fleet, return to manufacturer, or sale to third parties).

Within this context, the system provides a variety of user-facing applications and interfaces, including applications which may be installed and run on a mobile computing device of the user for various functions. These functions include, but are not limited to, user registration or enrollment, user reservation management, user access to a fleet vehicle, communication between the user and the fleet management system during use (including, but not limited to, providing roadside or emergency assistance), and return of the fleet vehicle.

In several exemplary embodiments, the present invention comprises one or more systems or applications for enrolling or registering users. Types of users vary depending on the nature of the fleet. For example, users may be employees of the owner of a corporate or municipal utility fleet, authorized drivers of a bus fleet, drivers of taxi-cabs, renters or customers of a car rental agency, or members of a car sharing service. Accordingly, the types of user registration or enrollment system will vary as well.

In general, the user enrollment or registration component collects necessary information from the users, and reviews potential users backgrounds and qualifications, including, but not limited to, user training, licensure reviews, background checks, and credit checks, as appropriate. In some business models, enrollment may comprise an application and acceptance as a member of a car sharing or similar service. Advertising or other means of solicitation of potential users may be included. In some cases, users may not be previously enrolled prior to an initial reservation or use, and some or all of these checks may be performed at the time the user reserves a vehicle or initially takes possession of a vehicle.

Users of a particular fleet may be divided into different categories or classifications (e.g., a preferred or frequent driver program for a car rental company, or users licensed for certain types of vehicles). In several embodiments, the system may comprise a “trusted user” program, where the user has meet certain pre-qualifications and undergone substantive background and credit checks. A “trusted user” may receive certain advantage and perquisites, such as access to special vehicles, quicker and easier access to vehicles, and quicker and easier returns.

In several embodiments, the present invention further comprises one or more reservation systems or applications. These comprise both user-facing and internal fleet system elements. An example of a multi-tiered fleet management reservations database caching system is described in U.S. Pat. No. 9,576,254 (issued Feb. 21, 2017 to Zipcar, Inc.), which is incorporated herein by specific reference for all purposes. Examples of a reservations interface for a user to identify available vehicles and make a reservation are provided in U.S. Pub. No. 2013/0226633 (published Aug. 29, 2013 by Zipcar, Inc.) and U.S. Pub. No. 2011/0060480 (published Mar. 10, 2011 by Zipcar, Inc.), which are incorporated herein by specific reference for all purposes.

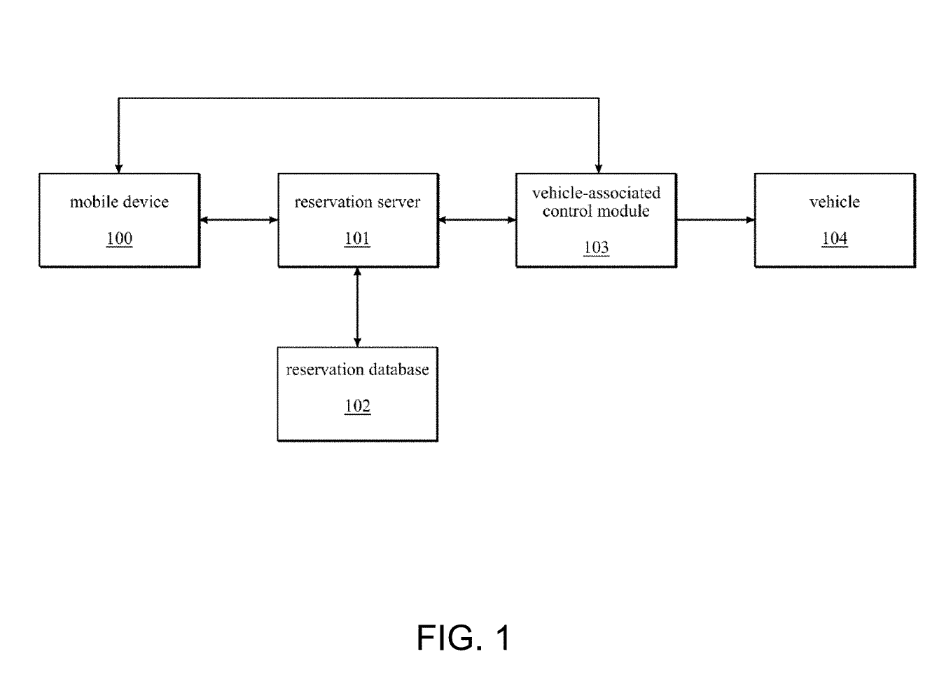

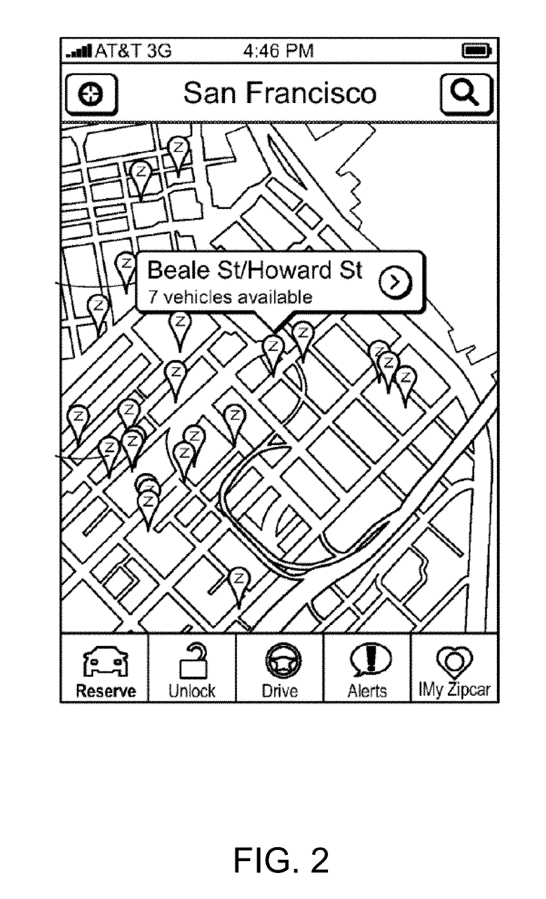

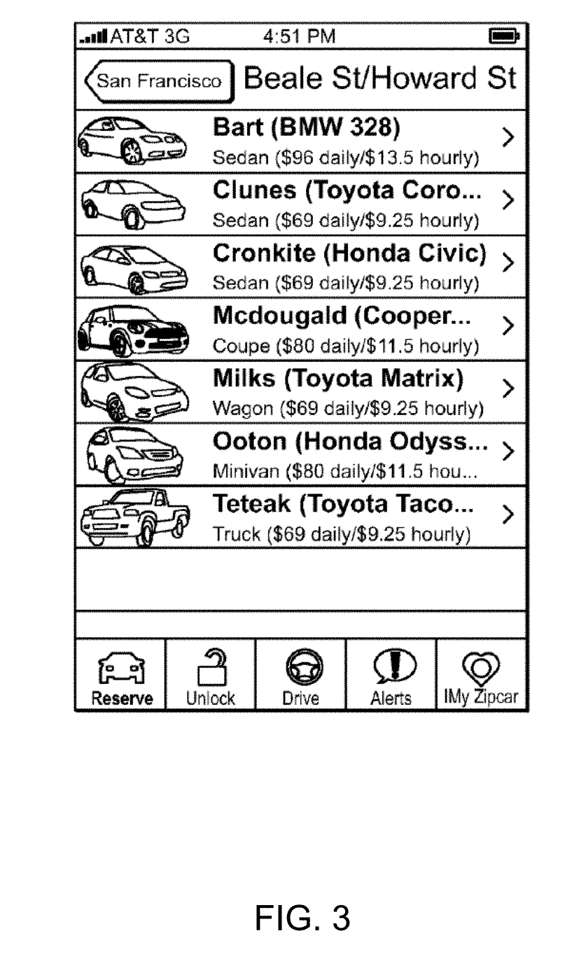

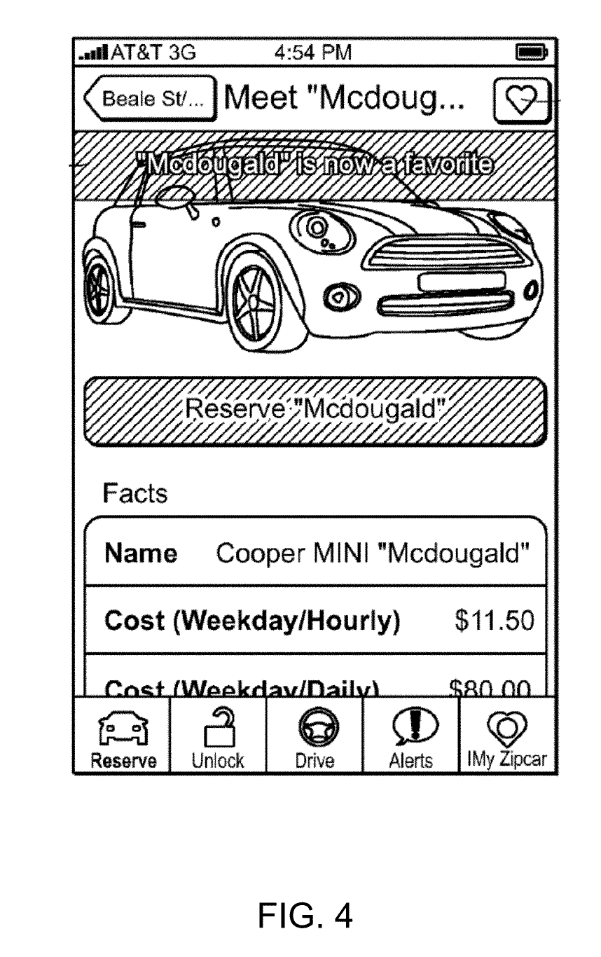

In one exemplary embodiment, for example, as seen in FIG. 1, a mobile device 100 runs a mobile device application for reserving and accessing a reservable asset, such as a vehicle 104. The mobile device application can be installed on the mobile device or it can be accessed through a web application. The mobile device electronically communications with a reservation server 101 that is part of a connected fleet management system. The reservation server is in communication with a reservation database 102. The reservation server provides information about reservable vehicles to the mobile device, including reservable assets (typically for a requested time period and location of interest). The mobile device application may display a map of locations of reservable vehicles, enabling users to search and view locations as desired, as seen in FIG. 2. The mobile device application also may display reservable vehicles in list format, as seen in FIG. 3. Users may mark certain vehicle types, or specific vehicles, as a “favorite,” as seen in FIG. 4, for facilitating future searches.

The present invention further comprises a vehicle access component, that also may comprise both user-facing and internal fleet system elements. This may be part of the reservations system or work in conjunction with a reservations system. The user seeks access in a variety of ways, including, but not limited to, obtaining keys to the vehicle from a car rental agent, presenting an authorized user card to a card reader in the vehicle, or using a mobile computing device to communicate with a TCU or dedicated access unit in the vehicle, as discussed above. Examples of access control systems are disclosed in U.S. Pat. No. 9,442,888 (issued Sep. 13, 2016 to Zipcar, Inc.) and U.S. Pat. No. 9,635,518 (issued Apr. 25, 2017 to Avis Budget Car Rental, LLC), which are incorporated herein by specific reference for all purposes.

In cases where the user is attempting key-less access to a connected vehicle, such as by wireless communication with a user's mobile computing device, there are several methods to determine whether to allow access. In some cases, access may be permitted if the user is a pre-authorized registered user, and presents a general access code or authorization to the vehicle. In other cases, reservation data (either for a single reservation or for reservations over a period of time, which can be a day or several days) has been previously electronically communicated to the vehicle (e.g., transmitted to a TCU in the vehicle) and stored therein, and access is permitted if a user attempting access matches corresponding reservation data (i.e., user identity, time period, and the like). Alternatively, after receiving an access request from a user, the vehicle (i.e., through TCU or similar unit) electronically communicates with the fleet management system to confirm whether or not to allow access. In cases where the vehicle cannot establish direct communication access, it may attempt to establish communication through other connected vehicles, through the user's mobile device, or other wireless access points.

In some cases, such as an underground garage or parking area, the vehicle and user's computing device may be unable to establish outside communications links in any fashion. In several embodiments, the fleet management system of the present invention previously provides a protected, secure, single-use token to the user's computing device upon making a reservation (or close to the starting time of the reservation), which is then securely communicated to the vehicle by the user's computing device through local wireless communications means (e.g., BLE, NFC, and the like). The vehicle processes the token, and allows access if the information in the token is valid.

After access is allowed, the period of use commences. During use, as described above, the connected vehicle (or a TCU or a similar unit in the vehicle) provides various information to the fleet management system. The fleet management system may directly or indirectly monitor some or all of the period of use.

In several embodiments, the fleet management system monitors the period of use for emergency situations, which may be reported by the user through an application on the user's mobile device or a unit in the vehicle. The user can establish connection directly with the fleet management system or an road-side assistance or emergency response team or service, and request assistance.

In several embodiments, the user may communicate an incident or accident in real-time or near real-time during the use period. Information may be gathered in real time by the user using the application on their mobile computing device, including descriptions and pictures of any damage to the vehicle. This information can then be provided to the fleet management system's servicing or maintenance components for advance planning and scheduling prior to return of the vehicle.

The user may be contacted if the fleet management system detects that the vehicle may be returned late, or at a different location than identified in the reservation, as described in U.S. Pub. No. 2013/0246102 (published Sep. 19, 2013 by Zipcar, Inc.) which is incorporated herein by specific reference for all purposes. The fleet management system can assist the user in extending or modifying the reservation if necessary, and may contact other users that may be affected by the late return.

The present invention further comprises vehicle return applications or components, which handle, among other things, determination of the vehicle status and condition, invoicing of the user (where appropriate), and forwarding of the vehicle for any servicing, maintenance, or repairs that may be required. These also may comprise user-facing and internal fleet elements. For example, a user may return a vehicle to a planned drop-off location, then automatically check-in through an application on their mobile computing device. The user may be prompted to confirm mileage and gas levels (which the connected vehicle may communicate directly to the fleet management system), and electronically sign the final invoice. An electronic receipt may be sent to the user through the application, email, or other form of electronic communication.

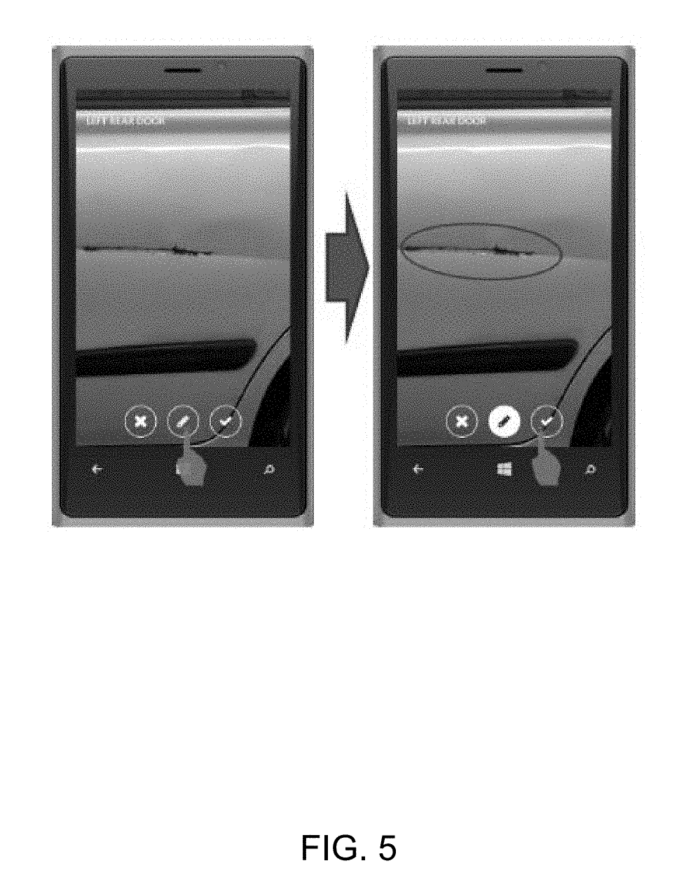

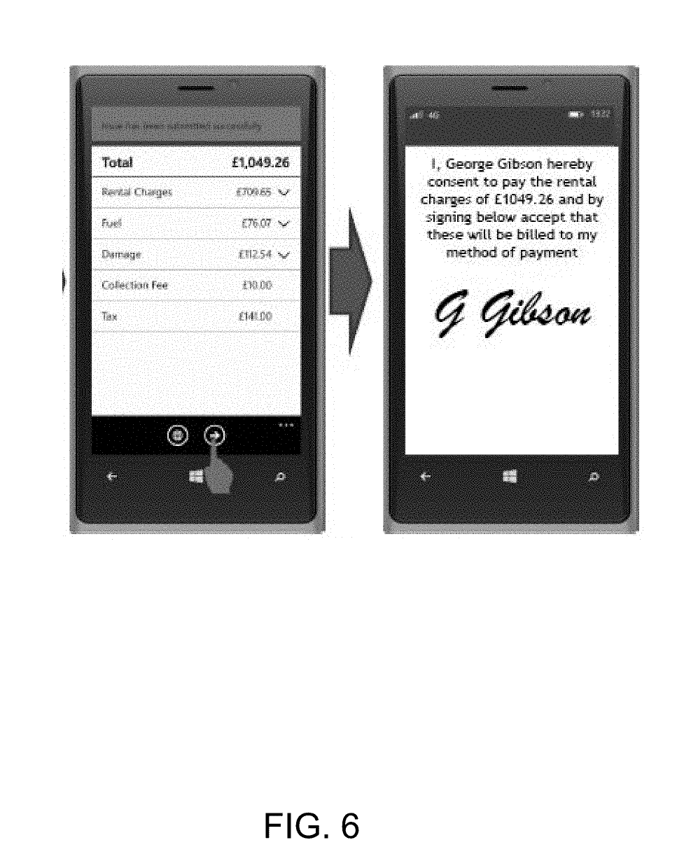

If the vehicle is damaged, the application may be used to record/photograph the damage, as seen in FIG. 5, and the system may then automatically, in real time, calculate a damage charge to add to the user invoice at the time of return. The mobile device may be used to capture the electronic signature of the customer or user returning the vehicle, as seen in FIG. 6, including the damage charge.

Travel Interruption

Connected users of fleet vehicles often do so in conjunction with air travel, or in some areas, rail travel. Unfortunately, air and rail travel is often subject to delays or cancellations due to weather, fire, mechanical problems, computer system malfunctions, or similar problems.

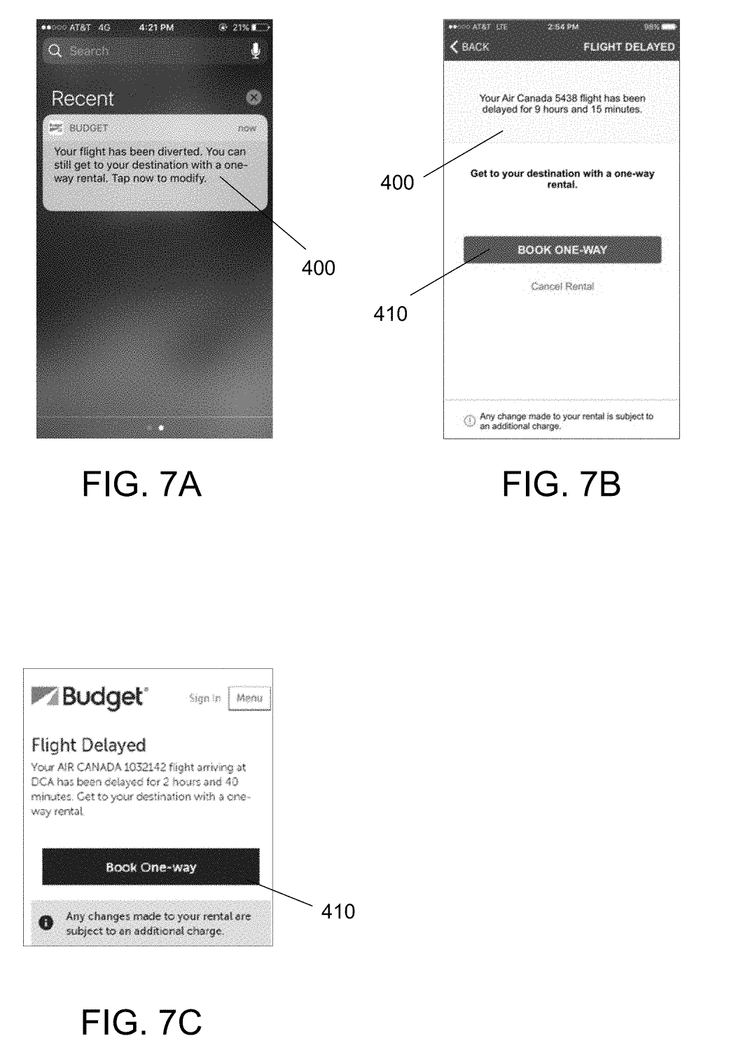

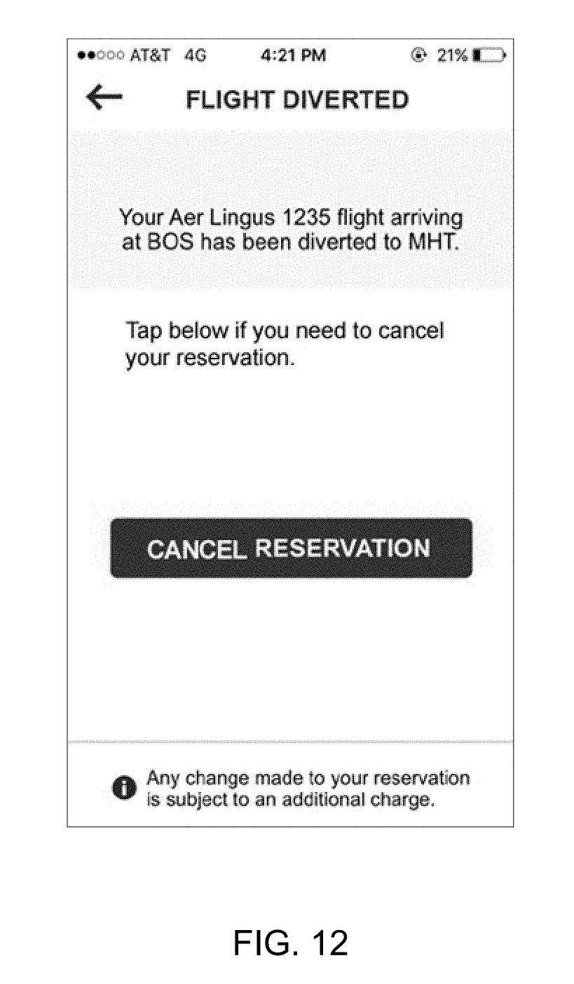

In several exemplary embodiments, as seen in FIGS. 7-15, the present invention comprises a travel disruption service that, depending on the situation, provides an alternative solution for a connected user to get to their desired destination, or to easily modify, change or cancel existing reservation data. While the discussion below refers to flight disruption events, it is understood that the invention also may be applied to rail/train disruption events, or the like.

For a connected user at a origination location with a reservation for a fleet vehicle at a destination location, the service provides the connected user an option to provide the airline name and flight number as part of the reservation. If the user has enabled push notifications through the system application on their mobile device, and/or has chosen to receive text messages (i.e., SMS text), the system can provide notifications to the user of changes in their flight information. Flight information can be obtained directly from the airline or airport, or travel services. For relatively minor flight delays, this allows the fleet system to automatically adjust the “pick-up” time of the vehicle at the destination location without requiring active modification of the reservation by the connected user.

The system may also provide notifications to the user if the user's flight experiences a flight disruption event. Flight disruption events include, but are not limited to, a flight delay for equal to or greater than a pre-determined threshold time, a flight diversion (e.g., an incoming flight is diverted to a different airport), or a flight cancellation (e.g., an individual flight cancelled, or origination and/or destination airports shut down). In several embodiments, before sending a flight disruption notice, the system first checks to ensure that no conflicting messages have been pushed or sent to the connected user.

The response options presented to the connected user with the message depend upon the distance between the origination airport and the destination airport, the timing of the vehicle reservation, and the circumstances of the flight disruption (e.g., length of flight delay, weather conditions in origination or destination locations, and the like).

If the distance between the flight origination location and the destination location is determined to be within a “drivable distance” (or a “drivable time”), the user may be provided the option to book a one-way vehicle rental and/or modify their reservation to a one-way vehicle rental from the origination location to the destination location. The vehicle reservation at the destination location is effectively canceled, and a substitute vehicle reservation at the origination location is made for one-way travel.

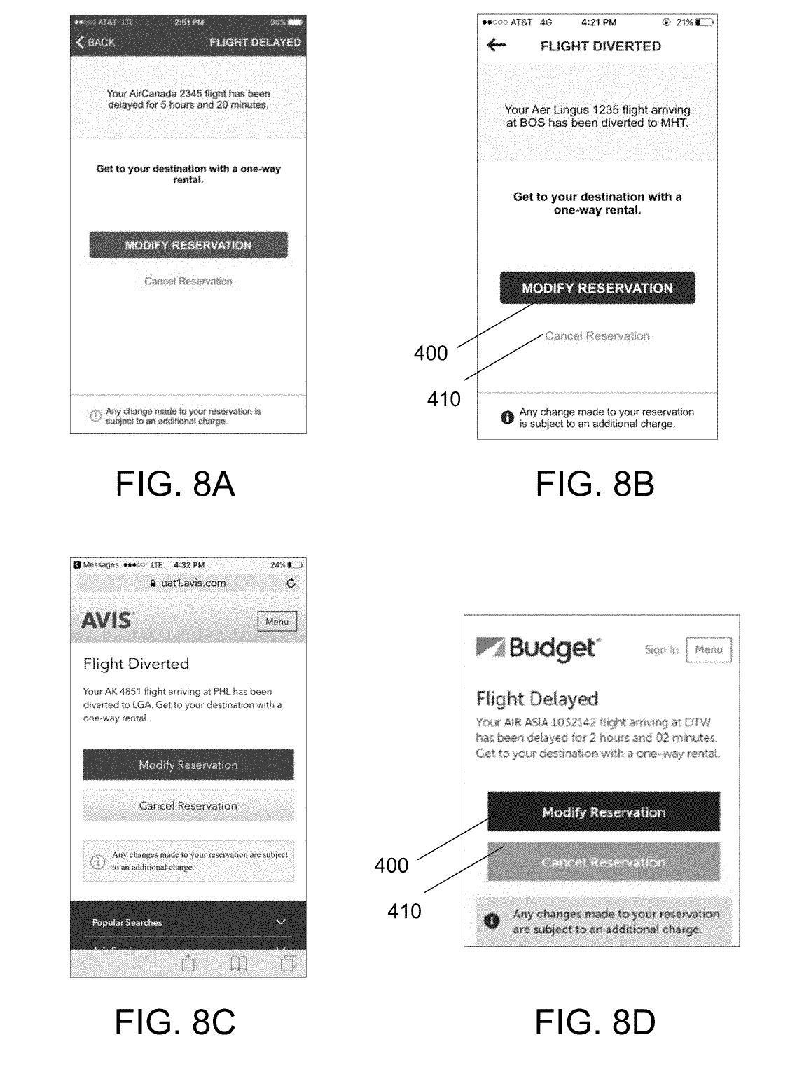

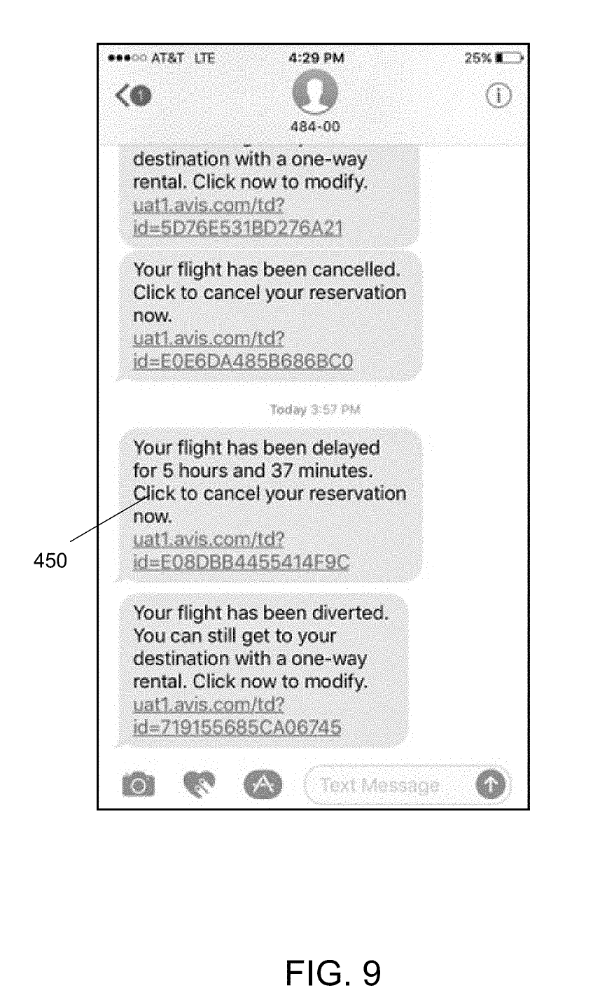

FIGS. 7A-C show examples of a mobile application notification 400 of a flight disruption event (e.g., flight delay, diversion, cancellation) with the suggested alternative travel option of booking a one-way vehicle rental. This option may be triggered by tapping the message or a booking icon 410. Similarly, FIGS. 8A-D show examples of a mobile application notification of a flight disruption event with suggested alternative travel option of modification 420 of an existing vehicle reservation or cancellation 430 of an existing vehicle reservation. Alternatively, or in addition, the notifications can be sent as a text message on the user's mobile device. FIG. 9 shows examples of a mobile device text message notification 450 of a flight disruption event (flight cancellation, delay, diversion) with suggested alternative travel options of a one-way vehicle rental, modification of an existing vehicle reservation, or cancellation of an existing vehicle reservation.

For the new or modified one-way reservation, the pick-up vehicle location can default to the origination location airport, although in some cases (such as when the user must still travel a significant distance to the origination location airport, or the original location airport itself is shutting down), the user may be provided other pick-up locations in the origination area from which to choose. The pick-up time may default to the original flight departure time, or a set time prior to the flight departure time (e.g., 1 to 2 hours prior), although the user may input another pick-up time. The vehicle may default to the same or similar vehicle type as made in the original vehicle reservation, although the user may select another available vehicle type. The default return time for the vehicle at the destination location may default to the return time for the original reservation (where an existing reservation is being modified) or to a set time (e.g., one or two hours) prior to the scheduled departure time for the return flight, although the user may input another return time.

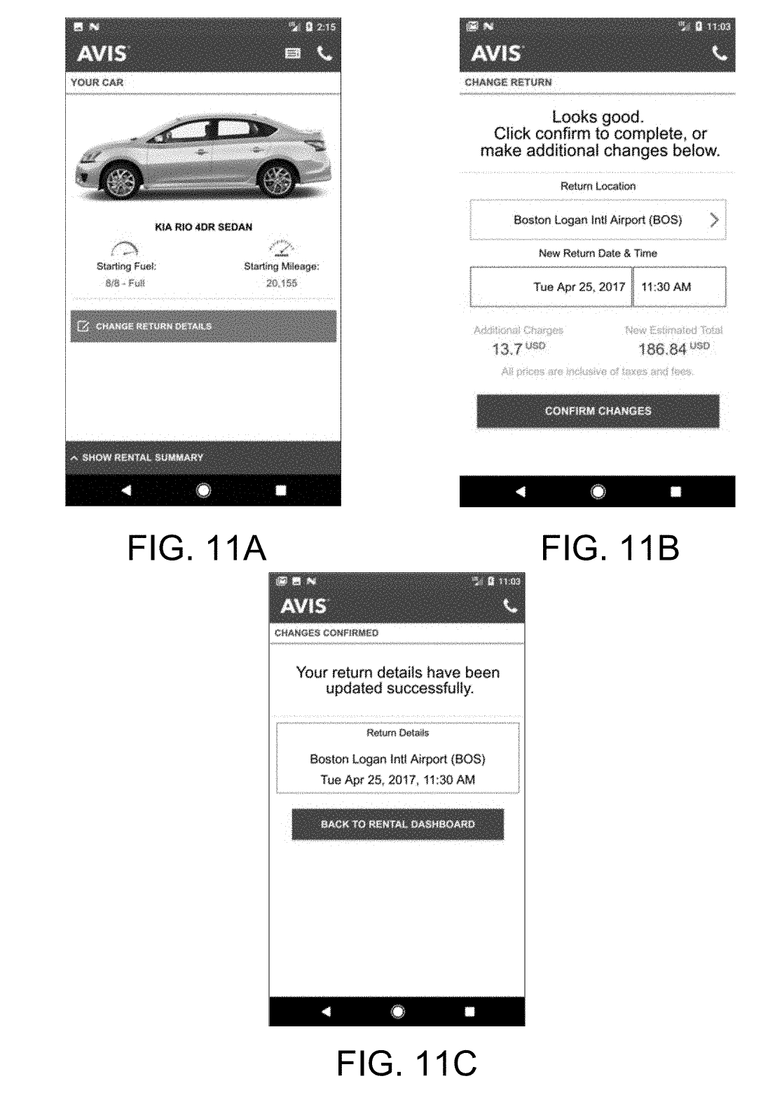

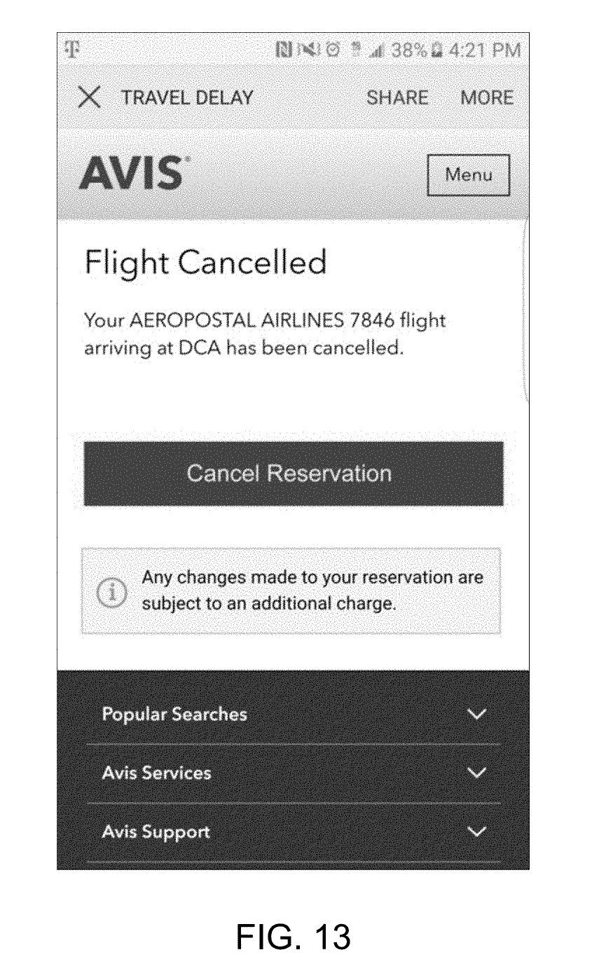

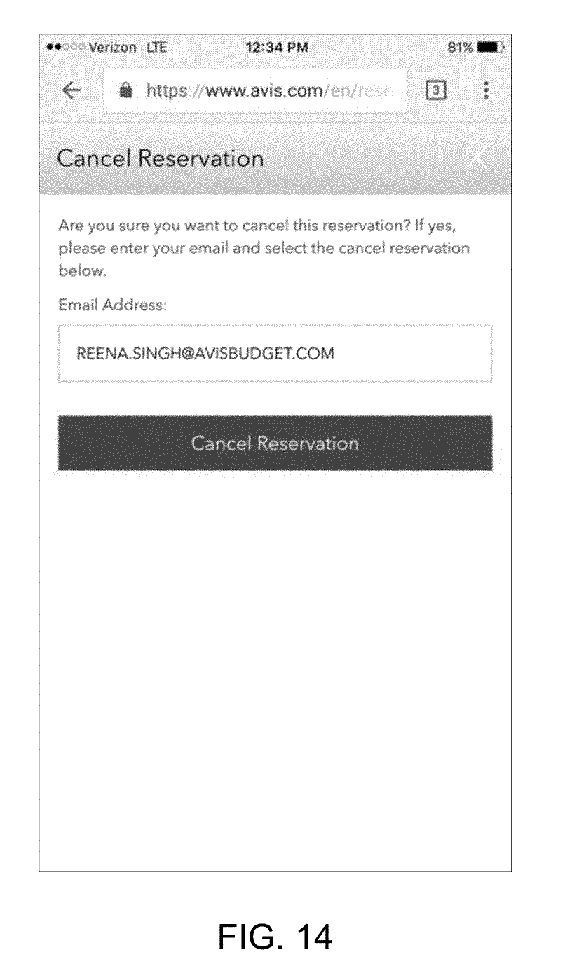

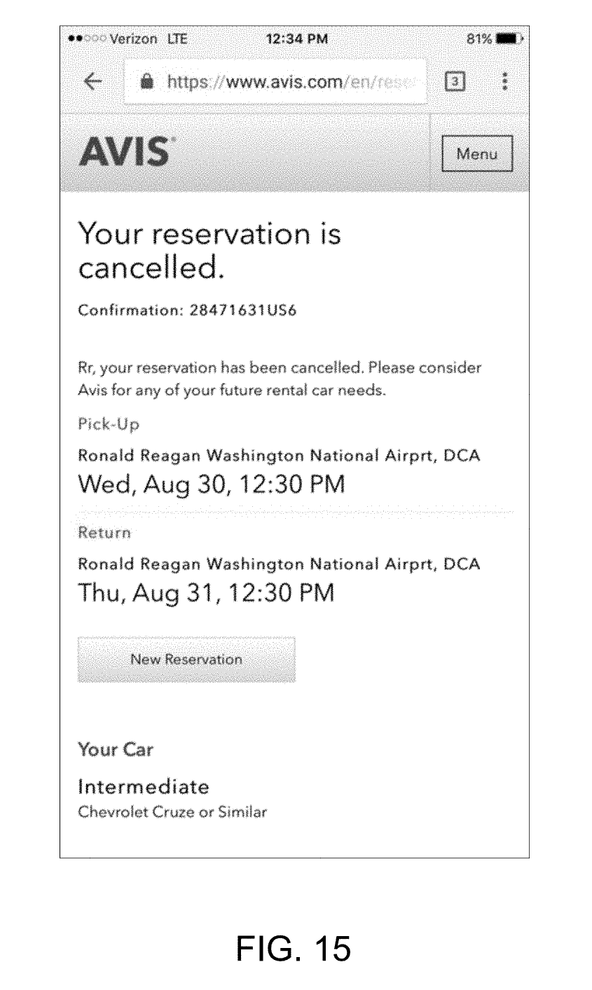

If the distance is not a drivable distance, or if the user decides not to accept the one-way booking option, the vehicle reservation at the destination location may otherwise be modified, or canceled entirely. In some cases, the user may be simply offered the option to cancel the reservation. FIGS. 11A-C show examples of mobile device application user interface screens for modification of an existing vehicle rental. FIG. 13 shows an example of a mobile application notification of a flight cancellation with the option to cancel an existing vehicle reservation, while FIGS. 14-15 show examples of mobile device application user interface screens for cancellation of an existing vehicle rental.

In several embodiments, the determination by the system whether to offer a one-way rental option incorporates a determination of whether the destination location is within a “drivable distance” (or, in some cases, “drivable time,” or a combination thereof). In one exemplary embodiment, the system maintains a “drivable distance” departure (origination) and destination locations (e.g., cities or airports) table. The drivable distance table determination for a particular pair of departure/destination locations may be based on the shortest or average or expected actual driving distance, the shortest or average or expected driving time, or a combination thereof. When a disruption event occurs, the system performs a simple table look-up to determines whether the departure/destination pair is considered to be within a drivable distance.

In other embodiments, the system may dynamically calculate the current driving distance and time based on distance (e.g., actual driving distance as discussed above), drive time (as discussed above) weather conditions, road and traffic conditions, and the like. The results of this dynamic determination are then compared to a pre-determined threshold value. The threshold value may vary based on location, season, and other factors.

In some embodiments, the user may specify a maximum drivable distance and/or time in their application preferences, so that the option for a one-way booking may be presented for distances (or times) other than the “drivable distance” or “drivable time” determined by the system.

The connected user then arrives at the vehicle rental origination location, accesses the reserved vehicle, drives the vehicle to the destination location, and uses the vehicle as planned. Assuming there are no problems with the departing return flight from the destination location, the user returns the vehicle at the destination location fleet vehicle facility and completes his or her travel. The user also may elect to drive the vehicle back to the origination location.

In some circumstances, the user may be in mid-travel when a flight disruption event arises. For example, the user may be on a flight that is diverted to a different location. In such a case, the system may send notifications of the event to the connected user (via push notification through the mobile application or via SMS text messaging, as described above), providing options depending upon the circumstances, such as booking or modifying their rental vehicle reservation to a one-way booking from the diversion location to the intended destination location.

Similarly, the user may already be in the destination location and in possession of a rental vehicle when the flight disruption event arises. The system sends notifications of the disruption event to the connected user (via push notification through the mobile application or via SMS text messaging, as described above), providing options depending upon the circumstances. For example, the user may be provided the option to modify the reservation at the destination location, typically by extending the rental and returning at a later time or date. In circumstances similar to those giving rise to the one-way option above, the user also may be provided the option to convert the vehicle rental to a one-way rental back to the connected user's origination location (or some alternative location).

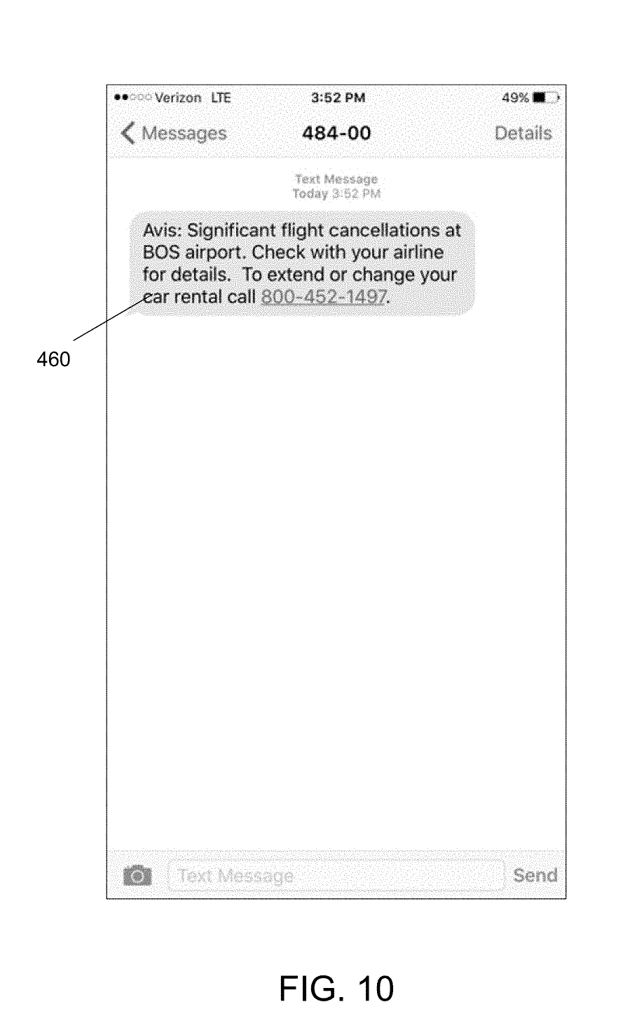

In several embodiments, the system may send notifications without a particular flight actually being formally delayed, diverted, or cancelled. For example, the system may detect a significant number of flight cancellations occurring at an airport, and as shown in FIG. 10, send a notification 460 to the user of the situation, providing them advance warning of a possible or probable flight event. Response or alternative travel options may then be offered as described above for a flight disruption event.

Connected Fleet Interaction

More detailed information about interactions between connected users and a connected fleet management system (including various applications and interfaces), and examples thereof, are disclosed in the pending application entitled “Connected Fleet Management System,” a copy of which is attached as an appendix to the above-reference provisional applications, and incorporated herein by specific reference for all purposes.

Computer Implementation

In order to provide a context for the various computer-implemented aspects of the invention, the following discussion provides a brief, general description of a suitable computing environment in which the various aspects of the present invention may be implemented. A computing system environment is one example of a suitable computing environment, but is not intended to suggest any limitation as to the scope of use or functionality of the invention. A computing environment may contain any one or combination of components discussed below, and may contain additional components, or some of the illustrated components may be absent. Various embodiments of the invention are operational with numerous general purpose or special purpose computing systems, environments or configurations. Examples of computing systems, environments, or configurations that may be suitable for use with various embodiments of the invention include, but are not limited to, personal computers, laptop computers, computer servers, computer notebooks, hand-held devices, microprocessor-based systems, multiprocessor systems, TV set-top boxes and devices, programmable consumer electronics, cell phones, personal digital assistants (PDAs), tablets, smart phones, touch screen devices, smart TV, internet enabled appliances, internet enabled security systems, internet enabled gaming systems, internet enabled watches; internet enabled cars (or transportation), network PCs, minicomputers, mainframe computers, embedded systems, virtual systems, distributed computing environments, streaming environments, volatile environments, and the like.

Embodiments of the invention may be implemented in the form of computer-executable instructions, such as program code or program modules, being executed by a computer, virtual computer, or computing device. Program code or modules may include programs, objects, components, data elements and structures, routines, subroutines, functions, and the like. These are used to perform or implement particular tasks or functions. Embodiments of the invention also may be implemented in distributed computing environments. In such environments, tasks are performed by remote processing devices linked via a communications network or other data transmission medium, and data and program code or modules may be located in both local and remote computer storage media including memory storage devices such as, but not limited to, hard drives, solid state drives (SSD), flash drives, USB drives, optical drives, and internet-based storage (e.g., “cloud” storage).

In one embodiment, a computer system comprises multiple client devices in communication with one or more server devices through or over a network, although in some cases no server device is used. In various embodiments, the network may comprise the Internet, an intranet, Wide Area Network (WAN), or Local Area Network (LAN). It should be noted that many of the methods of the present invention are operable within a single computing device.

A client device may be any type of processor-based platform that is connected to a network and that interacts with one or more application programs. The client devices each comprise a computer-readable medium in the form of volatile and/or nonvolatile memory such as read only memory (ROM) and random access memory (RAM) in communication with a processor. The processor executes computer-executable program instructions stored in memory. Examples of such processors include, but are not limited to, microprocessors, ASICs, and the like.

Client devices may further comprise computer-readable media in communication with the processor, said media storing program code, modules and instructions that, when executed by the processor, cause the processor to execute the program and perform the steps described herein. Computer readable media can be any available media that can be accessed by computer or computing device and includes both volatile and nonvolatile media, and removable and non-removable media. Computer-readable media may further comprise computer storage media and communication media. Computer storage media comprises media for storage of information, such as computer readable instructions, data, data structures, or program code or modules. Examples of computer-readable media include, but are not limited to, any electronic, optical, magnetic, or other storage or transmission device, a floppy disk, hard disk drive, CD-ROM, DVD, magnetic disk, memory chip, ROM, RAM, EEPROM, flash memory or other memory technology, an ASIC, a configured processor, CDROM, DVD or other optical disk storage, magnetic cassettes, magnetic tape, magnetic disk storage or other magnetic storage devices, or any other medium from which a computer processor can read instructions or that can store desired information. Communication media comprises media that may transmit or carry instructions to a computer, including, but not limited to, a router, private or public network, wired network, direct wired connection, wireless network, other wireless media (such as acoustic, RF, infrared, or the like), or other transmission device or channel. This may include computer readable instructions, data structures, program modules or other data in a modulated data signal such as a carrier wave or other transport mechanism. Said transmission may be wired, wireless, or both. Combinations of any of the above should also be included within the scope of computer readable media. The instructions may comprise code from any computer-programming language, including, for example, C, C++, C#, Visual Basic, Java, and the like.

Components of a general purpose client or computing device may further include a system bus that connects various system components, including the memory and processor. A system bus may be any of several types of bus structures, including, but not limited to, a memory bus or memory controller, a peripheral bus, and a local bus using any of a variety of bus architectures. Such architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing and client devices also may include a basic input/output system (BIOS), which contains the basic routines that help to transfer information between elements within a computer, such as during start-up. BIOS typically is stored in ROM. In contrast, RAM typically contains data or program code or modules that are accessible to or presently being operated on by processor, such as, but not limited to, the operating system, application program, and data.

Client devices also may comprise a variety of other internal or external components, such as a monitor or display, a keyboard, a mouse, a trackball, a pointing device, touch pad, microphone, joystick, satellite dish, scanner, a disk drive, a CD-ROM or DVD drive, or other input or output devices. These and other devices are typically connected to the processor through a user input interface coupled to the system bus, but may be connected by other interface and bus structures, such as a parallel port, serial port, game port or a universal serial bus (USB). A monitor or other type of display device is typically connected to the system bus via a video interface. In addition to the monitor, client devices may also include other peripheral output devices such as speakers and printer, which may be connected through an output peripheral interface.

Client devices may operate on any operating system capable of supporting an application of the type disclosed herein. Client devices also may support a browser or browser-enabled application. Examples of client devices include, but are not limited to, personal computers, laptop computers, personal digital assistants, computer notebooks, hand-held devices, cellular phones, mobile phones, smart phones, pagers, digital tablets, Internet appliances, and other processor-based devices. Users may communicate with each other, and with other systems, networks, and devices, over the network through the respective client devices.

As used herein, the singular forms “a,” “an” and “the” include plural referents unless the context clearly dictates otherwise. Further, the terms “additional”, “optional”, “optionally”, “may” and the like mean that the subsequently described operation, event or functionality mayor may not be required, and that the description includes instances where said operation, event or functionality occurs and instances where it does not. The word “comprise” and variations of that word, and the word “include” and variations of that word, mean “including but not limited to,” and are not intended to exclude, for example, other components, steps, or operations. “For example” and “exemplary” mean “an example of” and are not intended to convey an ideal embodiment.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. The system, methods and apparatus of the present invention are not limited to specific components, network connections, or arrangements described and disclosed herein, as such may vary. It is also to be understood that the terminology used herein is for the purpose of describing particular embodiments only, and is not intended to be limiting. Even though specific embodiments of this invention have been described, they are not to be taken as exhaustive. There are several variations that will be apparent to those skilled in the art.

What is claimed is:

1. A system for providing travel disruption and interruption services to a user of a fleet vehicle, comprising:
a mobile device with a microprocessor programmed to provide user services to a user of fleet vehicles in a connected fleet, said user services comprising:
sending a notification to the user of a travel disruption event affecting the user; and
providing the user the option to create, modify or cancel a fleet vehicle reservation in response to the travel disruption event.

2. The system of claim 1, wherein the travel disruption event is a flight delay or diversion.

3. The system of claim 1, wherein the travel disruption event is a flight cancellation.

4. The system of claim 1, wherein the travel disruption event is a significant number of flight cancellations at an airport, but not cancellation of a flight of the user.

5. The system of claim 1, wherein the notification is a push notification sent through a mobile device application on the user's mobile device.

6. The system of claim 1, wherein the notification is a text message sent through the user's mobile device texting service.

7. The system of claim 1, wherein the step of providing the user the option to create, modify or cancel a fleet vehicle reservation comprises:
determining an origination location and a destination location for a user flight affected by the travel disruption event;
determining whether the origination location and destination location are within a drivable distance and/or a drivable time of each other; and
offering a one-way vehicle rental from the origination location to the destination location if the origination location and destination location are within a drivable distance and/or a drivable time of each other.

8. The system of claim 1, wherein the step of determining whether the origination location and destination location are within a drivable distance and/or a drivable time of each other comprises a lookup on a data table of location/destination pairs.

9. The system of claim 1, wherein the step of determining whether the origination location and destination location are within a drivable distance and/or a drivable time of each other comprises determining an estimated driving distance and/or driving time for a fleet vehicle driven from the origination location to the destination location on a particular date.

10. The system of claim 1, wherein the option to modify a fleet vehicle reservation in response to the travel disruption event comprises extending a current ongoing reservation.
